(19) United States
(12) Patent Application Publication
(10) Pub. No.: US 2025/0239377 A1
(43) Pub. Date: Jul. 24, 2025

(54) HIGH-DEFINITION EMISSION TOMOGRAPHY IMAGE ACQUISITION DEVICE FOR HIGH DENSITY FUEL ASSEMBLY

(71) Applicant: UNIVERSITY INDUSTRY FOUNDATION, YONSEI UNIVERSITY WONJU CAMPUS, Wonju-si, Gangwon-do (KR)

(72) Inventors: Chul Hee MIN, Wonju-si, Gangwon-do (KR); Hyung Joo CHOI, Seoul (KR); Hyun Joon CHOI, Wonju-si, Gangwon-do (KR)

(21) Appl. No.: 18/700,700

(22) PCT Filed: Feb. 23, 2022
(86) PCT No.: PCT/KR2022/002651

§ 371 Date: May 17, 2024

(30) Foreign Application Priority Data
Oct. 13, 2021 (KR) 10-2021-0135726

(51) Int. Cl. G21C 17/06; G01N 23/046

(52) U.S. Cl. CPC G21C 17/06; G01N 23/046; G01N 2223/1013; G01N 2223/202; G01N 2223/316; G01N 2223/625

(57) ABSTRACT

A high-quality tomographic image acquisition device for a densely arranged spent nuclear fuel according to an embodiment of the present inventive concept relates to an gamma emission tomography device for detecting radiation of a fuel assembly which receives a plurality of fuel rods and may comprise: a first detection part disposed on one side of the fuel assembly and detecting radiation emitted from the fuel assembly; and a second detection part including a rod-shaped sealing part disposed inside the fuel assembly and a detection member disposed inside the sealing part and detecting radiation emitted from the fuel assembly.

### TECHNICAL FIELD

The present disclosure relates to a high-quality tomographic image acquisition device for densely arranged spent nuclear fuel.

### BACKGROUND ART

Spent nuclear fuel refers to nuclear fuel materials used in commercial or research reactors, or other nuclear materials fissioned by other methods.

Although there is no apparent difference between spent nuclear fuel and unspent nuclear fuel, spent nuclear fuel is changed in the composition of the materials due to neutron irradiation and nuclear fission chain reactions occurring within the reactor, and emits radiation and high heat.

Such spent nuclear fuel is currently handled through reprocessing, disposal, or temporary storage methods, and in this case, it is necessary to accurately verify and monitor the state of the spent nuclear fuel.

Various kinds of spent nuclear fuel verification technologies certified by the International Atomic Energy Agency, such as Cherenkov radiation inspection equipment, gamma-ray energy spectrum analysis equipment, and total neutron and gamma-ray inspection equipment, have several problems of indirectly inspecting using radiation per volume or of having high error rates. Accordingly, gamma emission tomography techniques for verifying spent nuclear fuel have been proposed.

The gamma emission tomography techniques allow for direct tomography imaging of spent fuel assembly, so researches on the gamma emission tomography techniques are actively progressing. However, as the number of nuclear fuel rods arranged within the spent fuel assembly increases, i.e., the spent nuclear fuel used in pressurized water reactor, there have been difficulties in acquiring internal tomography images and serious degradation in measurement efficiency. In this case, it may be difficult to determine the occurrence of defects and the locations of defects within the nuclear fuel rods of the spent fuel assembly.

### DISCLOSURE

### Technical Problem

Accordingly, the present inventive concept has been made in view of the above-mentioned problems occurring in the related art, and it is an object of the present inventive concept to provide a high-quality tomographic image acquisition device for a densely arranged spent nuclear fuel, which can effectively determine the presence and locations of defects in the fuel assembly by acquiring tomography images of the densely arranged fuel assembly through optimization in design of an gamma emission tomography image acquisition device using two types of radiation detection units inside and outside the fuel assembly based on Monte Carlo simulation.

### Technical Solution

To accomplish the above-mentioned objects, according to the present inventive concept, there is provided an gamma emission tomography image acquisition device for detecting radiation emitted from a fuel assembly accommodating a plurality of fuel rods, including: a first detection unit which is arranged outside the fuel assembly to detect radiation emitted from the fuel assembly; and a second detection unit which includes a rod-shaped sealing unit arranged within the fuel assembly, and detection members arranged within the sealing unit to detect radiation emitted from the fuel assembly.

The second detection unit includes a collimator, in which the detection members are arranged, the outer surface of which is surrounded by the sealing unit, and which has a slit formed on one side to allow radiation emitted from the fuel assembly to pass through.

The second detection unit includes a partition which divides an internal space of the collimator into a plurality of sections.

The detection members are formed in plurality and each of the detection members is arranged in each of the divided internal spaces.

The second detection unit has the axial direction corresponding to the axial direction of the fuel rods, so detects radiation emitted from the fuel assembly while rotating around the central axis.

The second detection unit is arranged such that the axial direction thereof corresponds to the axial direction of the fuel rods, and can move linearly in the axial direction.

The second detection unit has the axial direction corresponding to the axial direction of the fuel rods, so detects radiation emitted from the fuel assembly while rotating around the central axis, and can control the rotation angle depending on the number of detection members arranged.

The detection member is formed as a scintillator or a semiconductor detector.

### Advantageous Effect

The high-quality tomographic image acquisition device for the densely arranged spent nuclear fuel according to the present inventive concept can acquire tomography images of the fuel assembly through the optimization in the structure of the first and second detection units of the gamma emission tomography image acquisition device for the densely arranged spent nuclear fuel based on Monte Carlo simulation, and verify the presence and location of defects in the fuel assembly through the source generation locations shown in the tomographic images, thereby preventing additional defect occurrences and leakage of radioactive materials.

The high-quality tomographic image acquisition device for the densely arranged spent nuclear fuel according to the present inventive concept can detect radiation from both inside and outside by arranging the first detection units outside the fuel assembly and the second detection units inside the fuel assembly, thereby acquiring high-quality tomographic images even though the arrangement of the fuel assembly is increased.

### DESCRIPTION OF DRAWINGS

FIG. 1 is a plan view of a high-quality tomographic image acquisition device for a densely arranged spent nuclear fuel according to an embodiment of the present inventive concept.

FIG. 2 is a plan view of the fuel assembly according to an embodiment of the present inventive concept.

FIG. 3 is a perspective view of the fuel assembly and a second detection unit according to an embodiment of the present inventive concept.

FIG. 4 is a plan view illustrating the second detection unit according to an embodiment of the present inventive concept.

FIGS. 5 to 7 are plan views illustrating various structures of the fuel assembly according to an embodiment of the present inventive concept.

FIG. 8 is a plan view illustrating a second detection unit according to a modification of the present inventive concept.

FIG. 9 is a sinogram acquired from a first detection unit according to an embodiment of the present inventive concept.

FIG. 10 is a sinogram acquired from the second detection unit according to an embodiment of the present inventive concept.

FIG. 11 is a synthesis sinogram acquired by combining FIGS. 9 and 10.

FIG. 12 is a tomographic image acquired from the first detection unit according to an embodiment of the present inventive concept.

FIG. 13 is a tomographic image acquired from the first detection unit and the second detection unit according to an embodiment of the present inventive concept.

FIG. 14 is a view illustrating a source generation location of the fuel assembly based on the tomography image of FIG. 13.

### MODE FOR INVENTIVE CONCEPT

Hereinafter, embodiments of the present inventive concept will be described in detail with reference to the accompanying drawings so that a person of ordinary skill in the art can easily implement the embodiments of the present inventive concept. The present inventive concept can be implemented in various forms and is not limited to the embodiments described herein. In the drawings, parts not related to the description have been omitted for clarity, and the same reference numerals are used throughout the specification for the same or similar components.

In this specification, it should be understood that the terms of ‘include’ or ‘have’ in the specification are used to mean that there are characteristics, numbers, steps, operations, components, parts, or combinations of the steps, operations, components and parts described in the specification and there is no intent to exclude existence or possibility of other characteristics, numbers, steps, operations, components, parts, or combinations of the steps, operations, components and parts. Furthermore, when a part, such as a layer, a film, a region, or a plate, exists “on” another part, it may mean not only that the part is directly on another part but also that the other part is placed in between. Conversely, when a part, such as a layer, a film, a region, or a plate, exists “below” another part, it may mean not only that the part is directly below another part but also that the other part is placed in between.

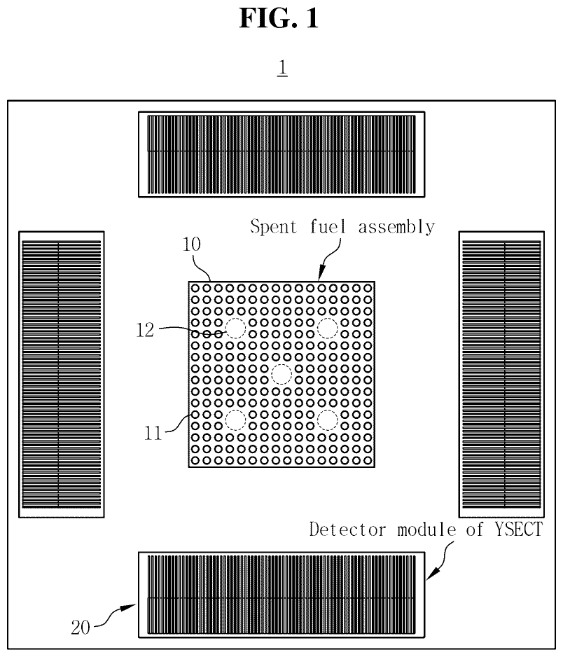

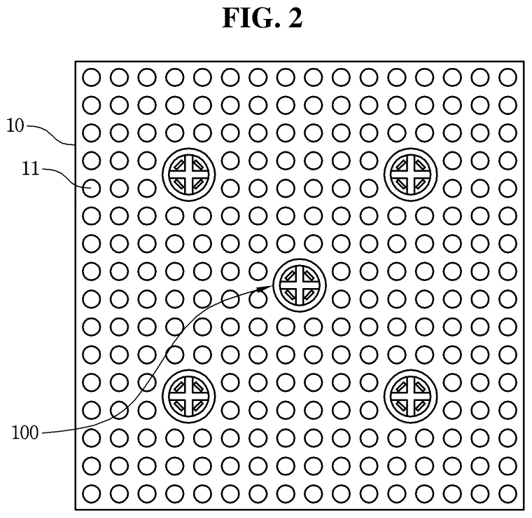

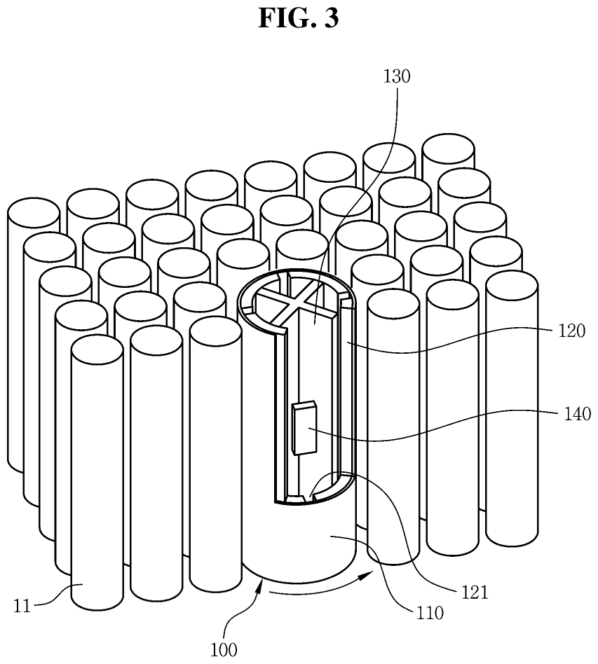

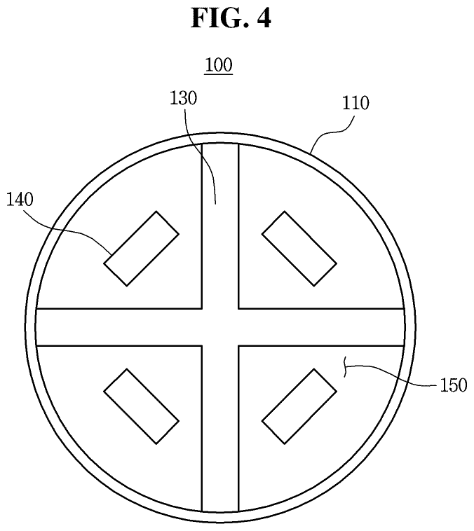

FIG. 1 is a plan view of a high-quality tomographic image acquisition device for a densely arranged spent nuclear fuel according to an embodiment of the present inventive concept, FIG. 2 is a plan view of the fuel assembly according to an embodiment of the present inventive concept, FIG. 3 is a perspective view of the fuel assembly and a second detection unit according to an embodiment of the present inventive concept, and FIG. 4 is a plan view illustrating the second detection unit according to an embodiment of the present inventive concept.

Referring to FIGS. 1 and 2, an tomographic image acquisition device 1 using an Yonsei single-photon emission computed tomography (YSECT) system according to an embodiment of the present inventive concept includes first detection units 20 and second detection units 100, thereby acquiring tomographic images of a fuel assembly 10.

The fuel assembly 10 can accommodate a plurality of fuel rods 11 arranged at predetermined intervals. Additionally, guide tubes 12 can be formed at predetermined locations within the fuel assembly 10, and the second detection units 100, which will be described later, can be positioned inside the respective guide tubes.

Moreover, the guide tubes 12 may also serve as paths into which control rods are inserted during the control of a neutron reactivity or the emergency shutdown of the reactor, to prevent explosion occurring by exceeding the critical point during nuclear power generation. For example, as illustrated in FIG. 1, the guide tubes 12 may be formed in each of five spaces formed inside the fuel assembly. In this instance, each guide tube 12 may occupy a space corresponding to four fuel rods 11.

The first detection units 20 may be positioned on one side of the fuel assembly 10. The first detection units 20 may be formed in plurality, and each of the first detection units may be arranged at a predetermined angular interval. For example, as illustrated in FIG. 1, four first detection units 20 can be arranged around the fuel assembly 10 at regular angular intervals. In this case, the plurality of first detection units 20 can detect radiation emitted from the fuel assembly 10 while rotating around the fuel assembly 10.

Meanwhile, to detect the fuel assembly 10, the first detection units 20 must rotate 360 degrees around the fuel assembly 10. In this instance, if there is one first detection unit 20, the first detection unit can rotate 360 degrees around the fuel assembly 10, if there are two first detection units 20, each of the two first detection units can rotate 180 degrees around the fuel assembly 10, and if there are four first detection units 20, each of the four first detection units can rotate 90 degrees around the fuel assembly 10. That is, the angle of rotation can vary depending on the number of the first detection units 20.

Each of the second detection units 100 is positioned inside each of the guide tubes 12 formed at the predetermined intervals within the fuel assembly 10 to detect radiation emitted from the fuel assembly 10. For example, the second detection unit 100 can be arranged in a space corresponding to four fuel rods 11 within the fuel assembly 10.

In addition, the plurality of second detection units 100 can be arranged to be spaced at predetermined intervals within the fuel assembly 10. For instance, as illustrated in FIG. 2, when the fuel assembly 10 has a 16×16 array, 16 fuel rods are arranged in the horizontal direction and 16 fuel rods are arranged in the vertical direction, and five second detection units 100 can be arranged to be spaced at predetermined intervals.

Additionally, the second detection units 100 can be arranged so that the axial direction of the second detection units 100 corresponds to the axial direction of the fuel rods 11. In this case, the second detection unit 100 can detect radiation emitted from the fuel assembly 10 while rotating around the central axis thereof.

Furthermore, the second detection unit 100 can detect radiation emitted from the fuel assembly 10 while moving linearly in the axial direction. For example, if the fuel rods 11 are longer than the second detection units 100, the second detection units 100 can enhance the defect pattern classification accuracy of the tomographic images by detecting radiation while moving linearly in the axial direction.

Meanwhile, the tomographic image acquisition device 1 may further include a tomographic image generation module (not illustrated). The tomography image generation module can create tomographic images of the fuel assembly 10 based on detection data received from at least one of the first detection unit 20 and the second detection unit 100.

Referring to FIGS. 3 and 4, the second detection unit 100 according to an embodiment of the present inventive concept can include a sealing unit 110, a collimator 120, a partition 130, and a detection member 140.

The sealing unit 110 has a cylindrical rod shape extending to a predetermined length, and the collimator 120, the partition 130, and the detection member 140 can be embedded in the sealing unit 110. For example, the sealing unit 110 can be formed to surround the outer surface of the collimator 120 to seal an internal space 150. For instance, the sealing unit 110 can be made of beryllium (Be) or stainless steel materials. Accordingly, the second detection unit 100 is protected from immersion by the sealing unit 110, so can be applicable to the fuel assembly 10 stored in a wet storage facility.

The collimator 120 has a hollow tube shape extending to a predetermined length, and the partition 130 and the detection member 140 can be arranged inside the collimator 120. The outer surface of the collimator 120 can be sealed by the sealing unit 110. The collimator 120 may be made of tungsten material.

Additionally, the collimator 120 may have a slit 121 formed to allow radiation emitted from the fuel assembly 10 to pass through. Accordingly, the collimator 120 can allow only radiation of a specific direction to pass through the slit 121 and absorb radiation incoming from other directions.

For instance, as illustrated in FIGS. 3 and 4, the slit 121 can be formed to penetrate from one side to the opposite side of the collimator 120. Alternatively, the slit 121 can be formed to be recessed to a predetermined depth from one side of the collimator 120. The slit 121 may extend in the longitudinal direction of the collimator 120. In addition, a plurality of the slits 121 can be spaced at predetermined intervals.

The partition 130 is placed within the internal space 150 of the collimator 120, and can divide the space into a plurality of parts. The partition 130 can extend in the longitudinal direction of the collimator 120, and can divide the internal space based on the central axis of the collimator 120. The detection members 140 can be arranged in each divided internal space.

For example, as illustrated in FIGS. 3 and 4, the partition 130 may have a cross-shaped section, and equally divide the internal space of the collimator 120 into four. In this case, the plurality of slits 121 can be arranged to correspond to each divided internal space 150 of the collimator 120. Therefore, each of the plurality of slits 121 can allow radiation to enter each internal space 150.

The detection member 140 is positioned inside the collimator 120, and can detect radiation passing through the slit 121. For instance, the detection member 140 may be a scintillator or a semiconductor detector that emits visible light by receiving radiation.

For instance, the detection members 140 may be formed in plurality, and each of the detection members 140 may be arranged in the divided spaces of the collimator 120. Alternatively, the detection members 140 may be positioned to face the slits 121 to increase the efficiency of radiation entering through the slits.

In this instance, the rotation angle of the second detection unit 100 can be controlled based on the number of the detection members 140. For example, as illustrated in FIGS. 3 and 4, if four detection members 140 are arranged at regular angular intervals, the second detection units 100 can detect radiation incoming from all directions around the second detection unit 100 by rotating only 90 degrees.

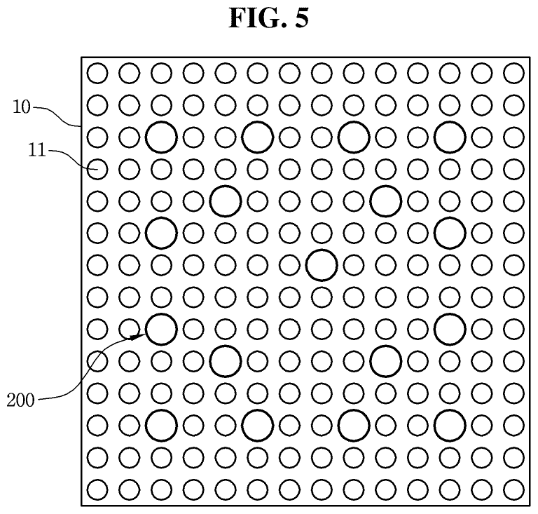

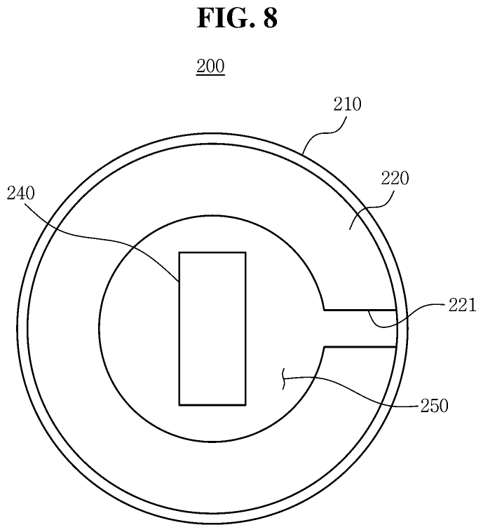

FIGS. 5 to 7 are plan views illustrating various structures of the fuel assembly according to an embodiment of the present inventive concept, and FIG. 8 is a plan view illustrating a second detection unit according to a modification of the present inventive concept.

As illustrated in FIGS. 5 to 7, the fuel assembly 10 according to an embodiment of the present inventive concept may have a 14×14 array, a 16×16 array, or a 17×17 array, and may have other various arrays. Guide tubes can be formed at specific locations inside the fuel assembly. For example, the guide tube may occupy the space corresponding to one fuel rod 11.

The second detection unit 200 can be positioned inside the guide tube formed at a specific location within the fuel assembly 10, and can detect radiation emitted from the fuel assembly 10. For example, the second detection unit 200 can be placed in a space corresponding to one fuel rod 11 within the fuel assembly 10.

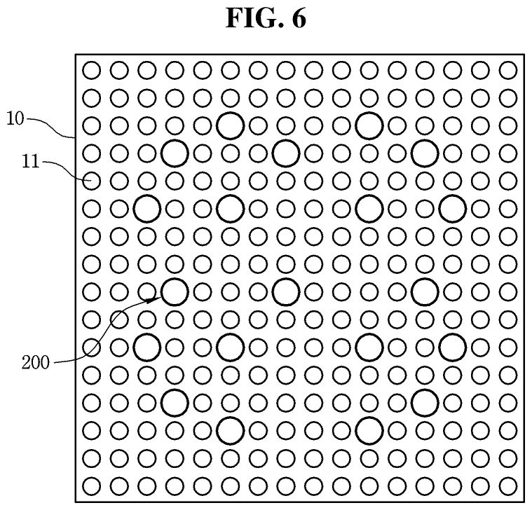

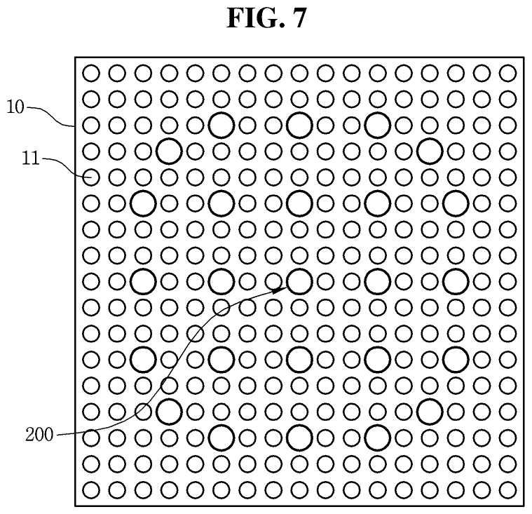

Furthermore, the plurality of second detection units 200 can be spaced at predetermined intervals within the fuel assembly 10. For instance, if the fuel assembly 10 has the 14×14 array as illustrated in FIG. 5, 17 second detection units 200 can be arranged to be spaced apart from each other. If the fuel assembly 10 has the 16×16 array as illustrated in FIG. 6, 21 second detection units can be spaced apart from each other, and if the fuel assembly 10 has the 17×17 array as illustrated in FIG. 7, 25 second detection units can be spaced apart from each other.

Referring to FIG. 8, the second detection unit 200 can include a sealing unit 210, a collimator 220, and a detection member 240. Since the sealing unit 210 performs the same function as the sealing unit 110 of the second detection unit 100 in a previously described embodiment, further details are omitted, and only differences related to other components will be described.

The collimator 220 may have the detection member 240 placed inside, and the outer surface of the collimator 220 can be sealed by the sealing unit 210. In addition, the collimator 220 may have a slit formed to allow radiation emitted from the fuel assembly 10 to pass through.

For example, as illustrated in FIG. 8, the slit 221 can be formed to penetrate from one side of the collimator 220 to the opposite side. Alternatively, the slit 221 can be formed to be recessed to a predetermined depth from one side of the collimator 220. In this case, the slit 221 can extend in the longitudinal direction of the collimator 220.

In a modification, the collimator 220 of the second detection unit 200 may have one slit 221 formed therein, and one detection member 240 can be placed within an internal space (250). The second detection unit 200 can detect radiation incoming from all directions around the second detection unit 200 by rotating 360 degrees around the central axis thereof.

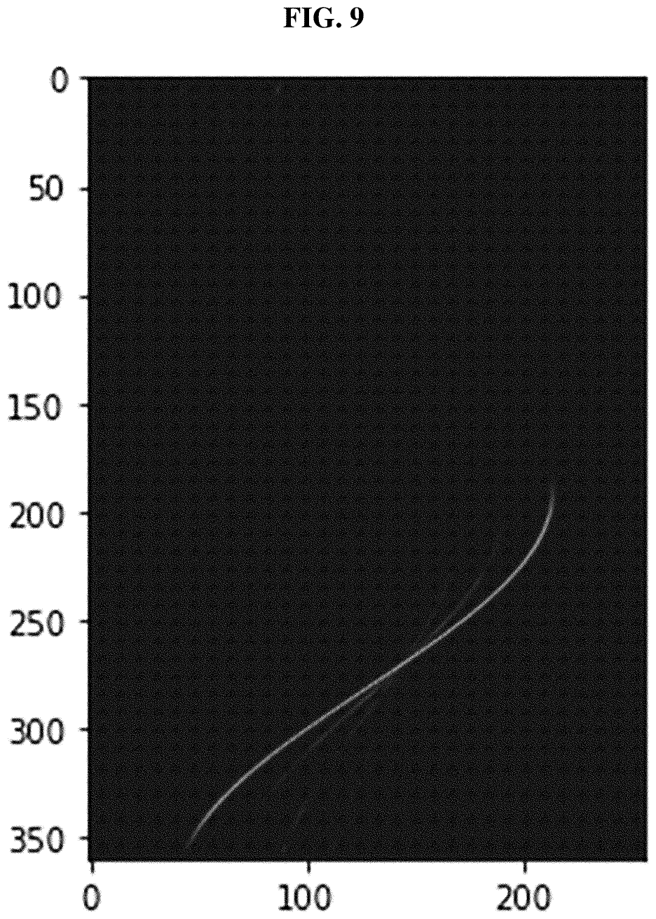

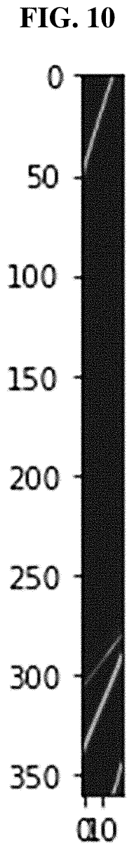

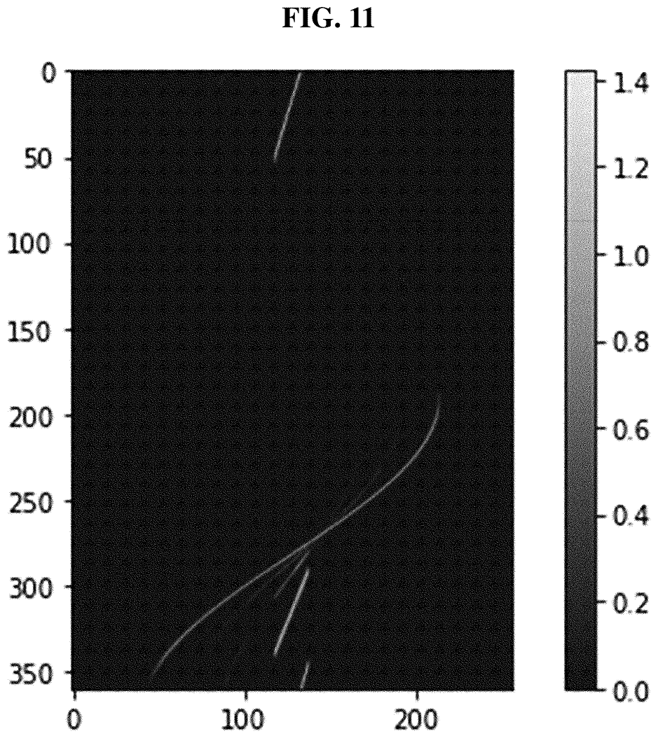

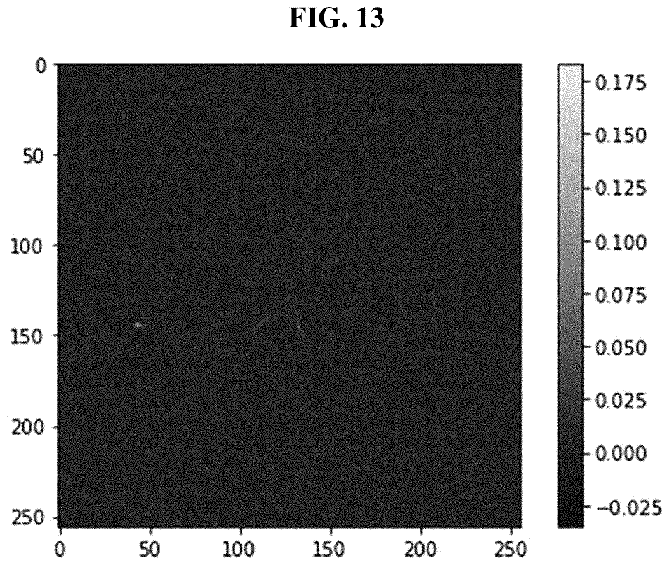

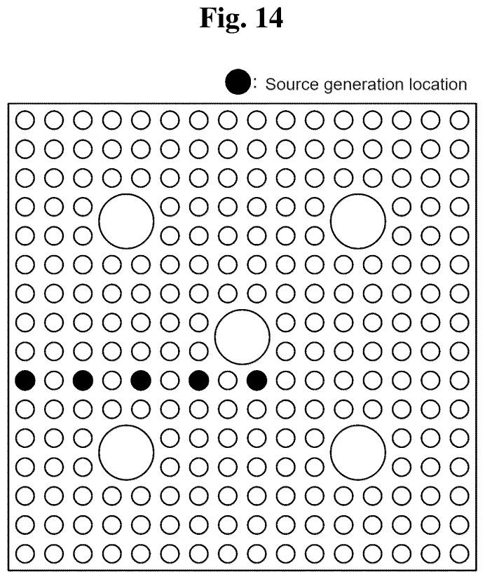

FIG. 9 is a sinogram acquired from the first detection unit according to an embodiment of the present inventive concept, FIG. 10 is a sinogram acquired from the second detection unit according to an embodiment of the present inventive concept, FIG. 11 is a composite sinogram acquired by combining FIGS. 9 and 10, FIG. 12 is a tomography image acquired from the first detection unit according to an embodiment of the present inventive concept, FIG. 13 is a tomography image acquired from the first detection unit and the second detection unit according to an embodiment of the present inventive concept, and FIG. 14 is a view illustrating a source generation location of the fuel assembly based on the tomographic image of FIG. 13.

As described above, the high-quality tomographic image acquisition device 1 for the high-density fuel assembly can create tomography images of the fuel assembly 10 based on detection data received from the first detection units 20 and the second detection units 100 through a tomographic image generation module (not illustrated).

Specifically, the tomographic image generation module can acquire a sinogram, which is two-dimensional data for an one-dimensional projection image illustrated in FIG. 9, through rotation of the first detection unit 20, and acquire a sinogram illustrated in FIG. 10 through rotation of the second detection unit 100. Additionally, the tomographic image generation module can produce a composite sinogram illustrated in FIG. 11 by combining the sinograms acquired from the first detection unit 20 and the second detection unit 100.

Moreover, the tomographic image generation module can reconstruct the acquired sinograms using image reconstruction algorithms to generate tomographic images.

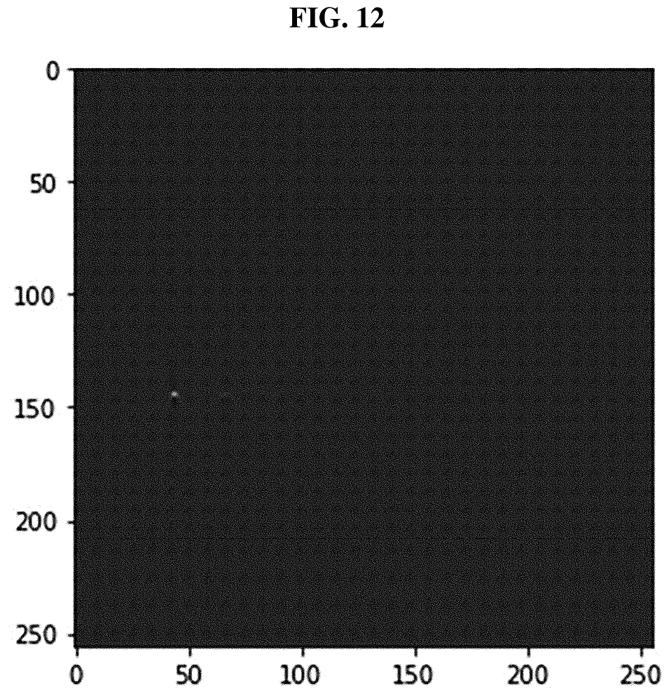

The tomographic image illustrated in FIG. 11 can be created by reconstructing the sinogram acquired from the first detection unit 20 as illustrated in FIG. 9. The tomographic image illustrated in FIG. 12 can be created by reconstructing the synthesis sinogram illustrated in FIG. 11 and acquired from both the first detection unit 20 and the second detection unit 100.

Comparing FIGS. 12 and 13, it can be observed that the spatial resolution has been improved when using both the first detection unit 20 and the second detection unit 100 rather than using only the externally located first detection unit 20, and the fuel rods located inside the fuel assembly could be distinguished. Accordingly, based on the tomography images acquired from the first and second detection units, the source generation locations as illustrated in FIG. 14 can be identified, thereby identifying the positions of the fuel rods where defects have occurred in the fuel assembly.

That is, as described above, the high-quality tomographic image acquisition device for the densely arranged spent nuclear fuel, which includes the first and second detection units, can effectively detect radiation generated inside the fuel assembly, improve the spatial resolution of the acquired tomographic images, and verify the presence and location of defects in the fuel assembly based on the source generation locations shown in the tomographic images, thereby preventing additional defect occurrences and leakage of radioactive materials.

Although the embodiments of the present inventive concept have been described, the spirit of the present inventive concept is not limited to the embodiments presented in this specification. A person skilled in the art could readily propose other embodiments by adding, changing, deleting, or supplementing components or parts within the same conceptual scope, and the additions, changes, supplements, and equivalents belong to the scope of the present inventive concept.

### SEQUENCE LIST TEXT

1: tomographic image acquisition device
10: fuel assembly 11: fuel rod
12: guide tube
20: first detection unit
100,200: second detection unit 110,210: sealing unit
120,220: collimator 121,221: slit
130: partition 140,240: detection member
150,250: internal space

1. The tomographic image acquisition device for detecting radiation emitted from a fuel assembly accommodating a plurality of fuel rods, comprising:
a first detection unit which is arranged outside the fuel assembly to detect radiation emitted from the fuel assembly; and
a second detection unit which includes a rod-shaped sealing unit arranged within the fuel assembly, and detection members arranged within the sealing unit to detect radiation emitted from the fuel assembly.

2. The tomographic image acquisition device according to claim 1, wherein the second detection unit includes a collimator, in which the detection members are arranged, the outer surface of which is surrounded by the sealing unit, and which has a slit formed on one side to allow radiation emitted from the fuel assembly to pass through.

3. The tomographic image acquisition device according to claim 2, wherein the second detection unit includes a partition which divides an internal space of the collimator into a plurality of sections.

4. The tomographic image acquisition device according to claim 3, wherein the detection members are formed in plurality and each of the detection members is arranged in each of the divided internal spaces.

5. The tomographic image acquisition device according to claim 1, wherein the second detection unit has the axial direction corresponding to the axial direction of the fuel rods, so detects radiation emitted from the fuel assembly while rotating around the central axis.

6. The tomographic image acquisition device according to claim 1, wherein the second detection unit is arranged such that the axial direction thereof corresponds to the axial direction of the fuel rods, and can move linearly in the axial direction.

7. The tomographic image acquisition device according to claim 3, wherein the second detection unit has the axial direction corresponding to the axial direction of the fuel rods, so detects radiation emitted from the fuel assembly while rotating around the central axis, and can control the rotation angle depending on the number of detection members arranged.

8. The tomographic image acquisition device according to claim 1, wherein the detection member is formed as a scintillator or a semiconductor detector.
